(19) United States
(12) Patent Application Publication
(10) Pub. No.: US 2025/0102762 A1
(43) Pub. Date: Mar. 27, 2025

(54) LENS BARREL, INTERCHANGEABLE LENS, AND IMAGE CAPTURING APPARATUS

(71) Applicant: CANON KABUSHIKI KAISHA, Tokyo (JP)

(72) Inventor: TOSHIMUNE NAGANO, Saitama (JP)

(21) Appl. No.: 18/887,584

(22) Filed: Sep. 17, 2024

(30) Foreign Application Priority Data
Sep. 21, 2023 (JP) 2023-155653

(51) Int. Cl. G02B 7/04; G02B 7/14

(52) U.S. Cl. CPC G02B 7/04; G02B 7/14

(57) ABSTRACT

Provided is a lens barrel having a compact size and good optical performance. A lens barrel includes a lens, a barrel that holds the lens and is movable in a direction along an optical axis, a base member that has a cylindrical shape and is positioned on an outer periphery of the barrel, a guide bar of which at least one end is fixed to the base member, and a guide unit that is fixed to the barrel by a fixing portion and has a biasing member configured to bias a first rotating element and a second rotating element to the guide bar, in which, on a plane perpendicular to the optical axis, distances between a first contact that is a point where the guide bar and the first rotating element are in contact with each other, a second contact that is a point where the guide bar and the second rotating element are in contact with each other, and the biasing member and an optical axis center are longer than a distance between a center of the guide bar and the optical axis center, as viewed along the optical axis, the guide unit overlaps the base member, and the biasing member is disposed between the first contact and the second contact.

### BACKGROUND

### Technical Field

The present disclosure relates to a lens barrel, an interchangeable lens, and an image capturing apparatus.

### Description of the Related Art

In lens devices that are used in video cameras, digital cameras, or the like, a lens device that guides a lens and a lens barrel holding the lens in an optical axis direction along a guide member extending in the optical axis direction is known. In such a configuration, if the lens device has a large mass, it is necessary to maintain a stable state with respect to a change in the influence of gravity due to a change in posture of the lens device. As a result, since a drive load in moving the lens is large, a lens device that has a lens barrel using a ball bearing to reduce the drive load is known.

Japanese Patent Laid-Open No. 2021-135428 discloses a structure in which a unit with a pair of ball bearings disposed in a V-shape is fastened to a lens barrel from an optical axis direction by screws and is biased into contact with a guide bar by a magnet provided in a barrel. International Publication No. WO2023/48001 discloses a structure in which two pairs of ball bearings disposed in a V-shape are brought into contact with a lens barrel further using ball springs for biasing.

To suppress tilting of a lens due to assembling or the like and to improve optical performance, it is necessary to secure strength of a base member holding a guide bar. In securing the strength of the base member within a limited size, it is effective to minimize a diameter of an opening portion.

### SUMMARY

According to embodiments of the present invention, A lens barrel as an aspect of the present invention includes a lens, a barrel that holds the lens and is movable in a direction along an optical axis, a base member that has a cylindrical shape and is positioned on an outer periphery of the barrel, a guide bar of which at least one end is fixed to the base member, and a guide unit that is fixed to the barrel by a fixing portion and has a biasing member configured to bias a first rotating element and a second rotating element to the guide bar, in which, on a plane perpendicular to an optical axis, distances between a first contact that is a point where the guide bar and the first rotating element are in contact with each other, a second contact that is a point where the guide bar and the second rotating element are in contact with each other, and the biasing member and an optical axis center are longer than a distance between a center of the guide bar and the optical axis center, as viewed along the optical axis, the guide unit overlaps the base member, and as viewed along the optical axis, the biasing member is disposed between the first contact and the second contact.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a lens barrel and a camera that configure an image capturing apparatus according to an embodiment.

FIG. 2 is a unit diagram illustrating elements that configure a fourth group unit according to the embodiment.

FIG. 3 is a configuration diagram illustrating a configuration of supporting the fourth group unit according to the embodiment to be drivable and controllable in an optical axis direction.

FIG. 4 is an external view illustrating a configuration of a guide unit according to the embodiment.

FIG. 5 is a cross-sectional view illustrating contacts of a main magnet and ball bearings with respect to a main guide bar as the lens barrel according to the embodiment is viewed from an object side along an optical axis.

FIG. 6 is a cross-sectional view illustrating elements that configure a guide according to the embodiment.

FIG. 7 is a cross-sectional view illustrating elements that configure position detection of the fourth group unit according to the embodiment.

FIG. 8 is an exploded perspective view of a lens barrel according to the embodiment.

FIG. 9 is an external view illustrating a receiving surface of a barrel unit during assembling of a guide unit base according to the embodiment.

FIG. 10 is a cross-sectional view illustrating a hole position of the lens barrel according to the embodiment.

### DESCRIPTION OF THE EMBODIMENTS

Hereinafter, a preferred embodiment of the present invention will be described using examples and drawings with reference to the accompanying drawings. In each drawing, the same members or elements will be given the same reference signs, and duplicate description will be omitted or simplified.

### First Embodiment

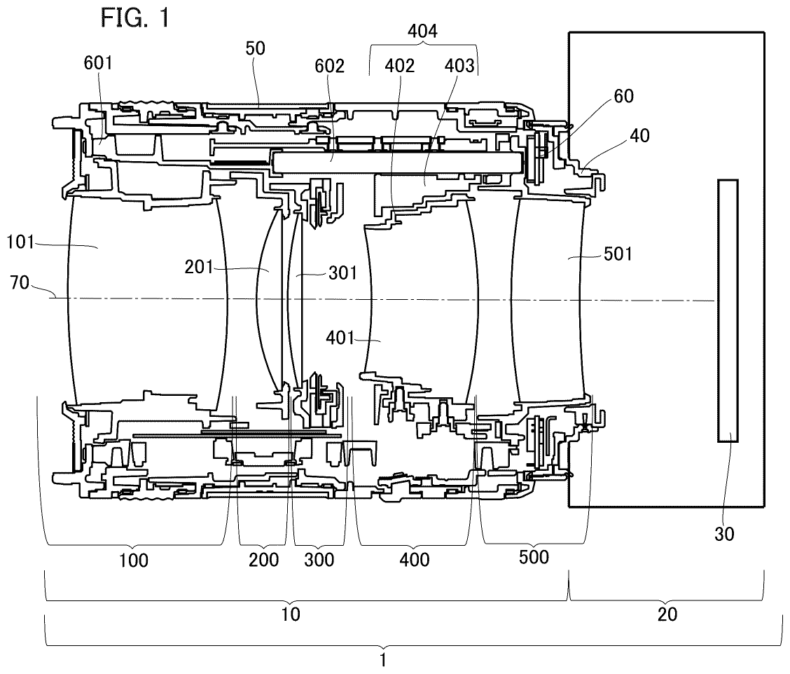

FIG. 1 is a diagram illustrating the configuration of a lens barrel 10 (lens device) and a camera 20 that configure an image capturing apparatus 1 according to the present embodiment.

The camera 20 has an image capturing element 30 and is configured to capture an image formed via the lens barrel 10. The lens barrel 10 is provided with a mount (mount portion) 40, and in the present embodiment, the lens barrel 10 and the mount 40 function as an interchangeable lens. The mount 40 has a configuration of being able to be mounted on a mount (not illustrated) of the camera 20, and can be connected to the camera 20 in a communicative manner by being mounted on the mount of the camera 20. Then, the mount 40 can fix the lens barrel 10 to the camera 20 by being mounted on the mount of the camera 20.

The lens barrel 10 has, in order from a subject side, a lens 101, a lens 201, a lens 301, a lens 401, and a lens 501 as optical elements. The lens 101 is held by a first group barrel, the lens 201 is held by a second group barrel, the lens 301 is held by a third group barrel, the lens 401 is held by a fourth group barrel, and the lens 501 is held by a fifth group barrel. Then, the lens barrel 10 has a first group unit 100 having the lens 101 and the first group barrel. Furthermore, the lens barrel 10 has a second group unit 200 having the lens 201 and the second group barrel. In addition, the lens barrel 10 has a third group unit 300 having the lens 301 and the third group barrel. In addition, the lens barrel 10 has a fourth group unit 400 having the lens 401 and the fourth group barrel. In addition, the lens barrel 10 has a fifth group unit 500 having the lens 501 and the fifth group barrel. Each unit is held by a base (base member) 601. The base 601 is a cylindrical member configured to be positioned on an outer periphery of each unit.

The second group unit 200 and the fourth group unit 400 are focus groups, and each of the second group unit 200 and the fourth group unit 400 is guided by a guide bar. Each of the second group unit 200 and the fourth group unit 400 are configured to be drivable and controllable by an actuator. Then, each of the second group unit 200 and the fourth group unit 400 is moved along an optical axis 70 by rotating an operation ring 50. With this, a position relationship of each of the second group unit 200 and the fourth group unit 400 in a direction along the optical axis 70 changes, and a focus position of the lens barrel 10 changes. Each actuator is driven and controlled by a main CPU 60.

The actuator of the second group unit 200 has an actuator configuration using a vibrator. Since a detailed configuration of the actuator of the second group unit 200 is known, detailed description thereof will be omitted. The actuator of the fourth group unit 400 has a configuration of a voice coil motor (VCM). Details of the voice coil motor will be described below.

The main CPU 60 is a central arithmetic device and controls the image capturing apparatus 1 by executing a control program stored in a memory (not illustrated). That is, the main CPU 60 performs overall control of respective components in the image capturing apparatus 1. The main CPU 60 controls the image capturing apparatus 1 by performing communication with a main CPU (not illustrated) on the camera 20 side. That is, the main CPU 60 receives a prescribed control signal from the main CPU on the camera 20 side and controls the image capturing apparatus 1 by executing the control program stored in the memory (not illustrated).

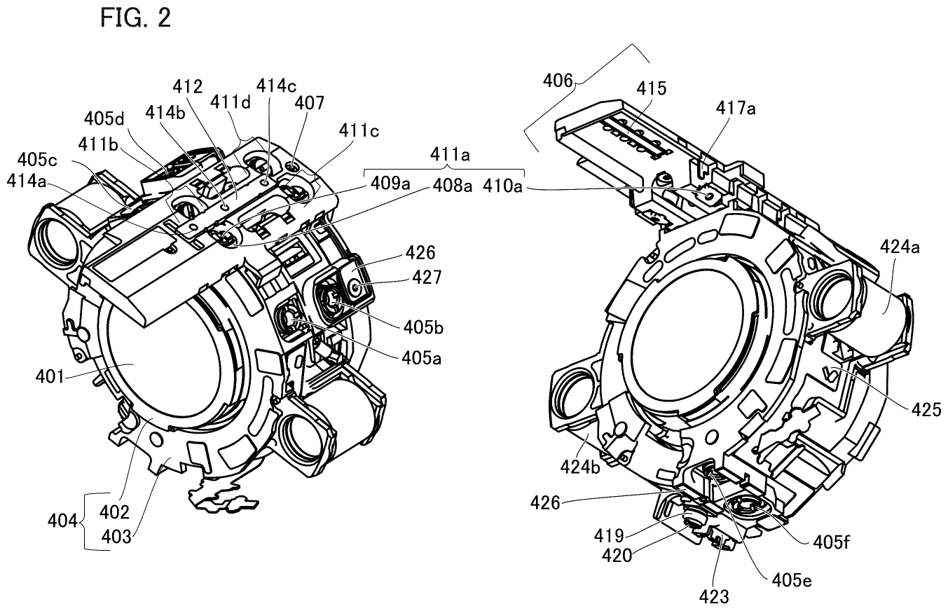

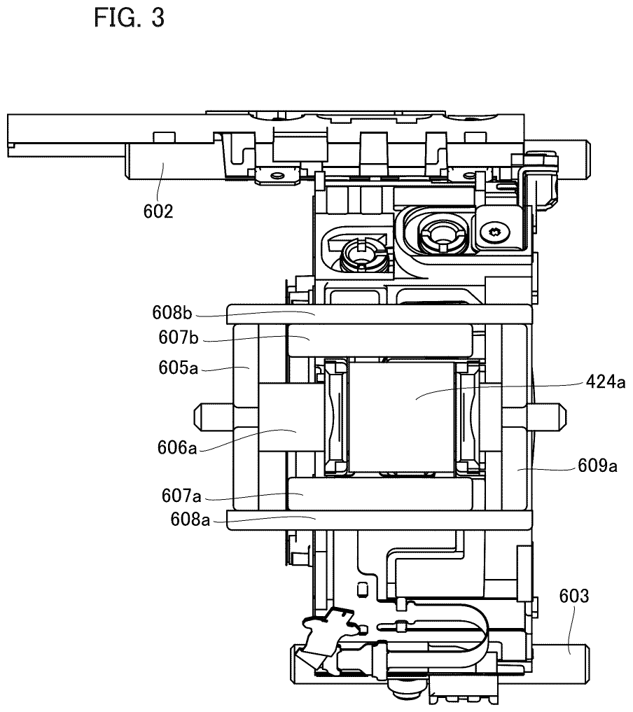

FIG. 2 is an example of a unit diagram illustrating elements that configure the fourth group unit 400. FIG. 3 is an example of a configuration diagram illustrating a configuration in which the fourth group unit 400 is supported to be drivable and controllable in an optical axis 70 direction.

The lens 401 held by the fourth group unit 400 is fixed to a barrel 402. The barrel 402 is held by a barrel base 403 to be adjustable by an 8 405a, an adjustment roller 405b, an adjustment roller 405c, an adjustment roller 405d, an adjustment roller 405e, and an adjustment roller 405f, and configures a barrel unit 404. Since an adjustment structure using the adjustment rollers is known, details thereof will be omitted.

A guide unit 406 that enables guiding to the main guide bar 602 fixed to the base 601 is fixed to the barrel unit 404. While a configuration of the guide unit 406 will be described below, with this configuration, the guide unit 406 rolls on ball bearings as rotating elements with respect to the main guide bar 602, and a tilt component and a guide direction of the barrel unit 404 with respect to the base 601 are determined. In this case, the guide unit 406 is biased to a sub-guide bar 603 by a sub-magnet (not illustrated) fixed to a sub-yoke 423, and the ball bearings and the sub-guide bar 603 are in contact with each other.

In the barrel unit 404, a ball bearing 419 that enables guiding to the sub-guide bar 603 fixed to the base 601 is rotatably held by a shaft screw 420. With this configuration, an eccentric component of the lens 401 with respect to the optical axis 70 of the lens barrel 10 is determined.

Both the main guide bar 602 and the sub-guide bar 603 have one end held by the base (base member) 601 and the other end held by the fifth group barrel (holding member) in the fifth group unit 500. In this way, one of the main guide bar 602 and the sub-guide bar 603 of the base member is fixed to the base 601, and the other guide bar is fixed by the fifth group barrel. In the present embodiment, the main guide bar 602 is made of a soft magnetic material such as SUS430.

The barrel unit 404 holds a coil 424a and a coil 424b that configure an actuator for driving. Furthermore, the barrel unit 404 holds a flexible cable 425 that applies a current to the coil 424a and the coil 424b. The flexible cable 425 makes a U-turn between the base 601 and the barrel base 403, and the barrel base 403 is movable in a guide direction with respect to the base 601.

Next, a configuration of a magnetic circuit of the actuator will be described. Inside the coil 424a, a center yoke 606a is disposed with a clearance and is fixed to the base 601. In front and at the back of the center yoke 606a in an optical axis OA direction, a front base yoke 605a and a rear base yoke 609a are attracted by magnets described below and are in contact with the center yoke 606a. The front base yoke 605a is fixed to the base 601 by screws. The front base yoke 605a and the rear base yoke 609a have planar portions substantially having the same distance on both sides in an arc direction with respect to the optical axis 70. The planar portions are substantially parallel with each other, and a back yoke 608a and a back yoke 608b that are attracted to the planar portions and held by a VCM magnet 607a (magnet) and a VCM magnet 607b (magnet) described below are provided. In this way, each yoke is attracted and held by a magnet such as the VCM magnet 607a or the VCM magnet 607b. The VCM magnet 607a and the VCM magnet 607b are fixed to the coil sides of the respective back yokes. In the present embodiment, a magnetic circuit is configured with the above-described configuration.

While details will be omitted, the coil 424b also has a similar configuration, and the barrel unit 404 can be driven in a direction to be guided by applying a current to the respective coils. Since the detailed principle and control are known techniques, description will be omitted.

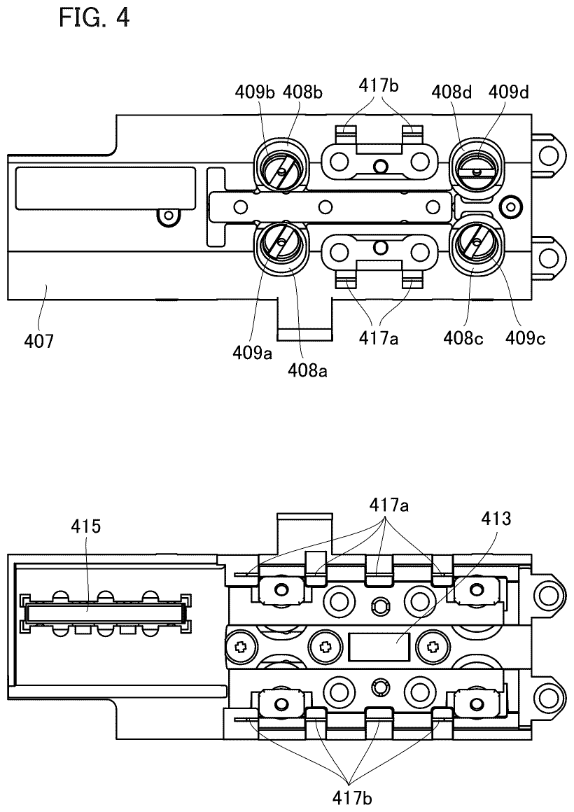

FIG. 4 is an external view illustrating a configuration of the guide unit 406. The guide unit 406 is made from a guide unit base 407 fixed to the barrel base 403. The main guide bar 602 is fixed to the guide unit base 407. In addition, four ball bearings for guiding while rolling are fixed as ball bearing units by shaft screws and nuts, respectively. That is, the guide unit base 407 of the present embodiment is configured to have the main guide bar 602 and ball bearing units 411a, 411b, 411c, and 411d.

Here, a ball bearing (first rotating element) 408a is fixed to the guide unit base 407 by a shaft screw 409a and a nut 410a. With this, the ball bearing unit 411a is configured. That is, the ball bearing unit 411a has the ball bearing 408a, the shaft screw 409a, and the nut 410a. A ball bearing (second rotating element) 408b is fixed to the guide unit base 407 by a shaft screw 409b and a nut 410b. With this, the ball bearing unit 411b is configured. That is, the ball bearing unit 411b has the ball bearing 408b, the shaft screw 409b, and the nut 410b. A ball bearing (third rotating element) 408c is fixed to the guide unit base 407 by a shaft screw 409c and a nut 410c. With this, the ball bearing unit 411c is configured. That is, the ball bearing unit 411c has the ball bearing 408c, the shaft screw 409c, and the nut 410c. A ball bearing (fourth rotating element) 408d is fixed to the guide unit base 407 by a shaft screw 409d and a nut 410d. With this, the ball bearing unit 411d is configured. That is, the ball bearing unit 411d has the ball bearing 408d, the shaft screw 409d, and the nut 410d. In this way, in the present embodiment, each of the four ball bearings is held in a state of a ball bearing unit.

The ball bearing unit 411a is held (fixed) on the subject side at a position substantially overlapping the ball bearing unit 411c as viewed from a direction along the optical axis 70. The ball bearing unit 411b is disposed (fixed) on the subject side at a position substantially overlapping the ball bearing unit 411d as viewed from the direction along the optical axis 70. Then, the ball bearing unit 411a is disposed at a position adjacent to the ball bearing unit 411b in a circumferential direction across the main guide bar 602.

The ball bearing unit 411c is held (fixed) on an image plane side at a position substantially overlapping the ball bearing unit 411a as viewed from the optical axis 70 direction. The ball bearing unit 411d is held (fixed) on the image plane side at a position substantially overlapping the ball bearing unit 411b as viewed from the direction along the optical axis 70. Then, the ball bearing unit 411c is disposed at a position adjacent to the ball bearing unit 411d in the circumferential direction across the main guide bar 602.

The guide unit base 407 has a main magnet (magnet) 413 serving as a biasing member for biasing to the main guide bar 602. Then, the main guide bar 602 is made of a soft magnetic material such as SUS430, so that magnetic attraction occurs, the guide unit base 407 is attracted to the main guide bar 602, and a biasing force is generated with respect to the main guide bar 602. That is, each ball bearing described above is brought into contact with the main guide bar 602 by the biasing force and rolls.

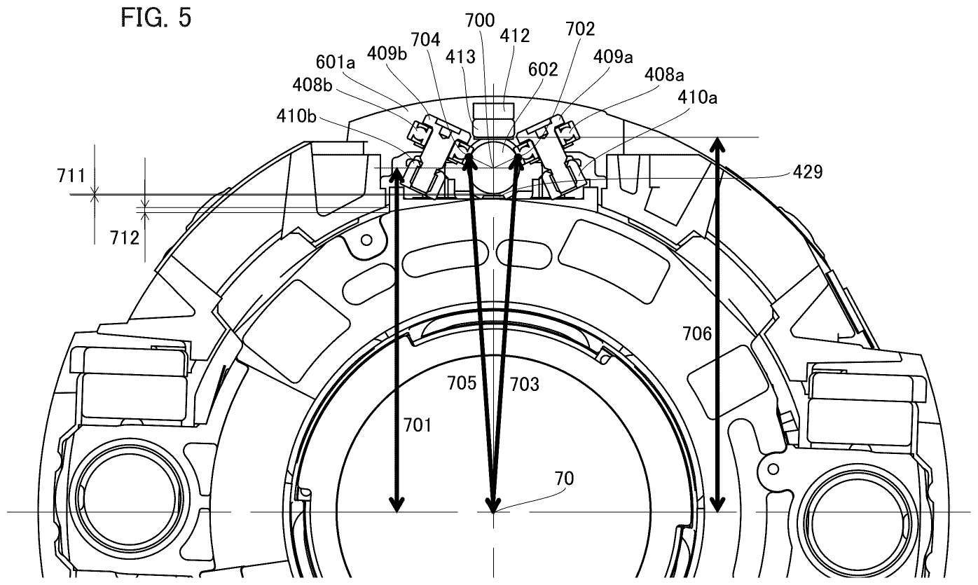

FIG. 5 is a cross-sectional view illustrating contacts of the main magnet 413 and the ball bearings with respect to the main guide bar 602 as the lens barrel is viewed from an object side along the optical axis. A position relationship of respective contacts (first contact and second contact) of the ball bearing 408a and the ball bearing 408b fixed to the guide unit base 407 (not illustrated), and the main guide bar 602 and the main magnet 413 in a cross section illustrated in FIG. 5 will be described.

A main guide bar center 700 of the main guide bar 602 and the optical axis 70 of the lens barrel 10 have a distance 701 on a plane perpendicular to the optical axis 70. A first contact 702, which is a contact point of the ball bearing 408a and the main guide bar 602, and the optical axis 70 have a distance 703 on the plane perpendicular to the optical axis 70. In this case, the distance 703 on the plane perpendicular to the optical axis 70 is longer than the distance 701. Then, the first contact 702 is on a right side (a right side in FIG. 5) with respect to a line connecting the main guide bar center 700 and the optical axis 70 as viewed from the object side.

A second contact 704, which is a contact point of the ball bearing 408b and the main guide bar 602, and the optical axis 70 have a distance 705 on the plane perpendicular to the optical axis. In this case, the distance 705 that is a distance on the plane perpendicular to the optical axis 70 is longer than the distance 701. Then, the second contact 704 is on a left side with respect to the line connecting the main guide bar center 700 and the optical axis 70 as viewed from the object side.

That is, the ball bearing 408a and the ball bearing 408b are in contact with the main guide bar 602 across the line connecting the main guide bar center 700 and the optical axis 70, so that the ball bearing 408a and the ball bearing 408b have the contacts (first contact and second contact) on the outer side of the main guide bar 602.

The main magnet 413 and the optical axis 70 have a distance 706 on the plane perpendicular to the optical axis 70. In this case, the distance 706 is longer than the distance 701, and the main magnet 413 is on the line connecting the main guide bar center 700 and the optical axis 70 as viewed from the object side. That is, as viewed from the optical axis 70 direction, the main magnet 413 is positioned between the ball bearing 408a and the ball bearing 408b. In other words, as viewed from the direction along the optical axis 70, the main magnet (biasing member) 413 is disposed between the first contact and the second contact. Then, the ball bearing 408a and the ball bearing 408b are magnetically attracted to the main guide bar 602 and are in contact with the main guide bar 602, so that the first contact 702 and the second contact 704 are configured and the positions thereof are uniquely determined.

In this way, on the plane perpendicular to the optical axis 70, the distances (distance 703, distance 705, and distance 706) between the first contact, the second contact, and the main magnet 413 and the optical axis center are longer than the distance (distance 701) between the main guide bar center 700 and the optical axis center.

As viewed from the direction along the optical axis 70, the ball bearing 408c overlaps the ball bearing 408a, and the ball bearing 408d overlaps the ball bearing 408b. Then, the ball bearing 408a and the ball bearing 408c, and the ball bearing 408c and the ball bearing 408d are at positions distant from each other in the optical axis 70 direction, and each ball bearing is fixed to the guide unit base 407.

The ball bearing 408c and the ball bearing 408d have a similar configuration to the ball bearing 408a and the ball bearing 408b described above. That is, the ball bearing 408c and the ball bearing 408d are in contact with the main guide bar 602 across the line connecting the main guide bar center 700 and the optical axis 70, so that the ball bearing 408c and the ball bearing 408d have contacts on the outer side of the main guide bar 602. Then, similarly to the above description, a third contact (not illustrated), which is a contact point of the ball bearing 408c and the main guide bar 602, and the optical axis 70 have a distance similar to the distance 703 on the plane perpendicular to the optical axis 70. In addition, a fourth contact (not illustrated), which is a contact point of the ball bearing 408d and the main guide bar 602, and the optical axis 70 have a distance similar to the distance 705 on the plane perpendicular to the optical axis 70.

Then, as viewed from the direction along the optical axis 70, the main magnet 413 is positioned between the ball bearing 408c and the ball bearing 408d. In other words, as viewed from the direction along the optical axis 70, the main magnet (biasing member) 413 is disposed between the third contact and the fourth contact. Then, the ball bearing 408a and the ball bearing 408b are magnetically attracted to the main guide bar 602 and are in contact with the main guide bar 602, so that the third contact and the fourth contact are configured, and the positions thereof are uniquely determined.

In this way, on the plane perpendicular to the optical axis 70, distances between the third contact, the fourth contact, and the main magnet 413 and the optical axis center are similarly longer than the distance (distance 701) between the main guide bar center 700 and the optical axis center.

As described above, in the present embodiment, each ball bearing has a contact point with respect to the main guide bar 602. Then, a configuration is made in which the ball bearings are in contact with the main guide bar 602 at the four contact points in total, so that tilting of the guide unit base 407 and the barrel unit 404 can be determined.

The ball bearings, the main yoke 412, and the main magnet 413 overlap a connecting portion 601a of the base 601 on the image plane side as viewed from the optical axis 70 direction. That is, a configuration is made such that the guide unit base 407 and the connecting portion 601a overlap as viewed from the optical axis 70 direction, it is possible to provide a width in a radial direction (a direction perpendicular to the optical axis). Thus, it is possible to reduce an opening portion and to increase the strength of the base 601. Though described below, the main yoke 412 is fixed to the guide unit base 407 by a screw 414a, a screw 414b, and a screw 414c. That is, the guide unit base 407 also has the main yoke (reinforcing member) 412.

With the configuration as described above, it is possible to bring the main guide bar 602 close to the barrel unit 404. Furthermore, since the lens barrel 10 has a cylindrical shape, each ball bearing, the main magnet 413, and the main yoke 412 can be disposed on an arc with the optical axis 70 as a center. Thus, it is possible to reduce the fourth group unit 400 in diameter.

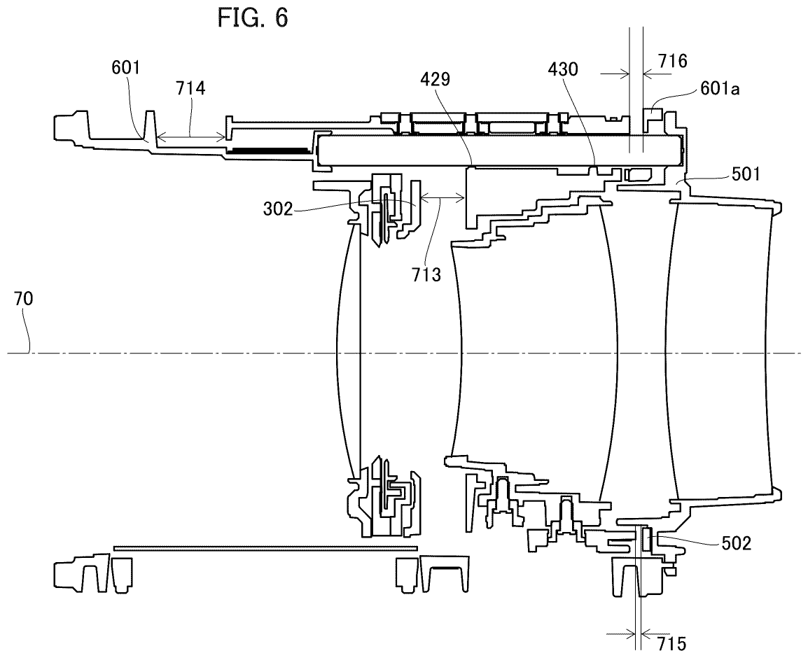

FIG. 6 is a cross-sectional view illustrating elements that configure a guide in the present embodiment. Here, as described above, the base 601 holes one end of the main guide bar 602 on the object side in the optical axis direction. Furthermore, the fifth group barrel holds the other end of the main guide bar 602 on the image plane side in the optical axis direction. As described above, the guide unit base 407 is guided to the main guide bar 602 while the ball bearings are in contact with the main guide bar 602 at four points.

With such a configuration, as the lens barrel is viewed from the object side along the optical axis, the barrel unit 404, the main guide bar 602, the guide unit base 407, the four ball bearings, the main magnet 413, and the main yoke 412 overlap the base 601. Furthermore, as viewed from the image plane side in the optical axis direction, the guide unit base 407, the four ball bearings, the main magnet 413, and the main yoke 412 overlap the base 601.

That is, in the present embodiment, the base 601 can connect the spaces of the guide unit base 407, the four ball bearings, the main magnet 413, and the main yoke 412 front and back. With this, it is possible to secure the strength of the base 601, and to hold the fourth group unit 400 with high accuracy. Furthermore, as described above, since the main guide bar 602 is brought close to the barrel unit 404, it is possible to configure the lens barrel 10 more compact.

The main guide bar 602 is held by the fifth group barrel without overlapping the base 601 as viewed from the image plane side in the optical axis direction. Furthermore, the barrel unit 404 is configured to enter an inner diameter of the base 601 from the image plane side without overlapping the base 601 as viewed from the image plane side in the optical axis direction. An assembling method and a configuration to permit the assembling method will be described below.

A clearance 713 (third clearance) is a distance between the barrel unit 404 and a third group cover 302 that configures the third group unit 300, which is a part closest to the barrel unit 404 in the optical axis 70 direction on the object side. In this case, the third group cover 302 is fixed to the third group barrel by screws (not illustrated), and the third group barrel is fixed to the base 601 by screws (not illustrated). That is, the third group cover 302 is a fixing member (first fixing member) that is fixed to the base 601.

A clearance 714 (fourth clearance) is a distance between the guide unit 406 and the base 601 that is a part closest to the guide unit 406 in the optical axis 70 direction on the object side. Then, the clearance 713 is a clearance smaller than the clearance 714. In other words, the distance of the clearance 713 is shorter than the distance of the clearance 714 in the optical axis 70 direction. In this case, the clearance 713 is smaller than the clearance 714 in the state of the lens barrel 10. In this way, the clearance 713 and the clearance 714 are provided in the lens barrel 10, in collision against the object side, the heavy barrel unit 404 for holding the lens 401 collides earlier. That is, after the barrel unit 404 and the third group cover collide, the guide unit 406 and the base 601 collide.

That is, the energy of the fourth group unit 400 in collision is consumed in collision with the third group cover 302, it is possible to reduce energy applied between the barrel unit 404 and the guide unit 406. As a result, it is possible to prevent an integrated state of the barrel unit 404 and the guide unit base 407 from being changed. That is, it is possible to suppress a change in tilting of the lens 401 with respect to the main guide bar 602, and to suppress deterioration of optical performance due to a shock.

A clearance 715 (fifth clearance) is a distance between the barrel unit 404 and a buffer member 502 fixed to the fifth group barrel, which is a part closest to the barrel unit 404 in the optical axis 70 direction on the image plane side. That is, the buffer member 502 is a fixing member (second fixing member) fixed to the base 601. A clearance 716 (sixth clearance) is a distance between the guide unit 406 and the base 601, which is a part closest to the guide unit 406 in the optical axis 70 direction on the image plane side. Then, the clearance 715 is a clearance smaller than the clearance 716. In other words, the distance of the clearance 715 is shorter than the distance of the clearance 716 in the optical axis OA direction. In this case, the clearance 715 is smaller than the clearance 716 in the state of the lens barrel 10, and the same as described above can be said on the image plane side.

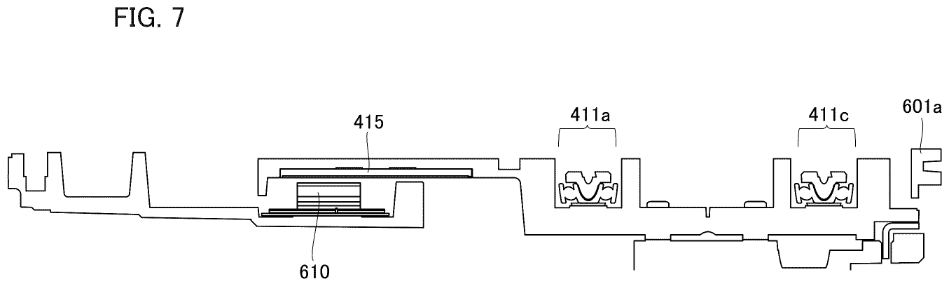

FIG. 7 is a cross-sectional view illustrating elements that configure position detection of the fourth group unit 400 in the exemplary embodiments. Here, as illustrated in FIG. 7, a scale 415 for performing absolute position detection of a lens is fixed to the guide unit base 407. Furthermore, a detection sensor (light emitting sensor) 610 that can detect an absolute position of a lens by emitting light to the scale 415 and receiving reflected light is fixed on an outer periphery side of the base 601. The scale 415 and the detection sensor 610 for position detection described above also function as a position detection unit that can detect a position of a lens.

As described above, the guide unit base 407 is in contact with the main guide bar 602, and tilting is determined. Furthermore, the main guide bar 602 is held by the base 601 and the fifth group barrel. That is, the scale 415 is held by the guide unit base 407 as in the present configuration, so that it is possible to reduce the inclination of the scale 415 with respect to the optical axis 70 according to the number of parts, and to detect the position of the fourth group unit 400 with high accuracy.

The ball bearing unit 411a and the scale 415 overlap as viewed from the optical axis 70 direction. Furthermore, at least the ball bearing unit 411a and the detection sensor 610 overlap as viewed from the optical axis 70 direction. The guide unit 406 rotates around the main guide bar 602 to absorb a part error for holding the ball bearing 419. Here, with the configuration of the lens barrel 10 of the present embodiment, it is possible to reduce a change in clearance of the scale 415 and the detection sensor 610 due to rotation.

The scale 415 is disposed on the object side with respect to each ball bearing. Furthermore, the fixing portion of the guide unit base 407 and the barrel unit 404 is on the image plane side. In this case, a reinforcing plate 417a and a reinforcing plate 417b extend to both sides in the optical axis direction across the main yoke 412.

The reinforcing plate 417a and the reinforcing plate 417b are members having a rigidity different from that of the guide unit base 407. Specifically, the reinforcing plate 417a and the reinforcing plate 417b are made of metal having a Young's modulus higher than that of the guide unit base 407, and are insert-molded in the guide unit base 407. The reinforcing plate 417a and the reinforcing plate 417b are provided in the guide unit base 407 across a fixing portion (screw 418a), the first contact 702, and the second contact 704 as viewed from the direction perpendicular to the optical axis. In such a manner, it is possible to obtain an effect of suppressing shaking of the scale 415 due to vibration, and to make a structure resistant to an external disturbance such as vibration.

Similarly, the main yoke 412 is also made of metal having a Young's modulus higher than that of the guide unit base 407 and is fixed to the guide unit base 407 by a screw 414a, a screw 414b, and a screw 414c across the ball bearing 408a. The main yoke 412 is fixed to the guide unit base 407 across the fixing portion (screw 418a), the first contact 702, and the second contact 704 as viewed from the direction perpendicular to the optical axis. In such a manner, similarly to the above description, it is possible to obtain an effect of suppressing shaking of the scale 415 due to vibration, and to make a structure resistant to an external disturbance such as vibration.

As described above, the detection sensor 610 is disposed outside (on the outer periphery side of) the base 601 that holds each lens, and with a configuration in which light is emitted outward with respect to the optical axis 70, it is possible to suppress a situation in which emitted light is exposed to the inside, that is, the image capturing element 30 and becomes a ghost. Even if the detection sensor 610 is disposed on the object side with respect to the fourth group unit 400, a similar effect is obtained.

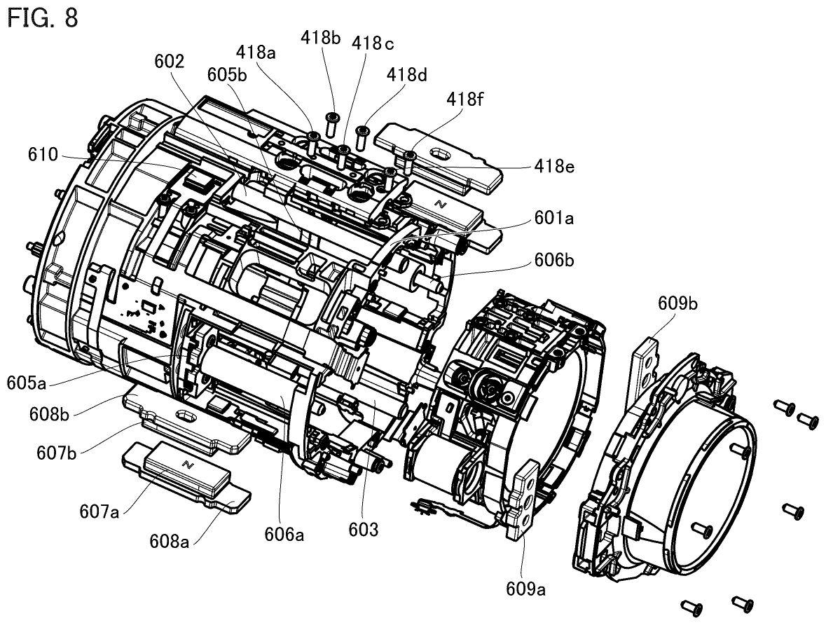

FIG. 8 is an example of an exploded perspective view of the lens barrel 10 of the present embodiment. An assembling method of the lens barrel 10 of the present embodiment will be described with reference to FIG. 8. The front base yoke 605a and a front yoke base 605b for use in a VCM are fixed to the base 601 by screws from the image plane side in the optical axis direction. Next, the center yoke 606a and a center yoke 606b for use in a VCM are inserted and held into holes of the base 601 and the front yoke bases. Then, the main guide bar 602 and the sub-guide bar 603 that holds the fourth group unit 400 to be movable in the optical axis 70 direction are inserted and held into the hole of the base 601 from a rear side in the optical axis OA direction.

Thereafter, the barrel unit 404 is inserted from the image plane side in the optical axis direction and fits to the inner diameter side of the base 601. Then, the shafts of the center yoke 606a and the center yoke 606b, and the rear base yoke 609a and a rear base yoke 609b for use in a VCM are inserted from the image plane side in the optical axis direction. In this case, the rotation of the rear base yoke 609a and the rear base yoke 609b is regulated by the base 601. Then, the fifth group barrel having a hole shape for holding the main guide bar 602, the sub-guide bar 603, the center yoke 606a, and the center yoke 606b is fixed to the base 601 by screws from the image plane side in the optical axis direction.

Next, a method for incorporating the guide unit 406 in the barrel unit 404 will be described in detail. The guide unit 406 is fixed to the barrel unit 404 by fastening a screw 418a, a screw 418b, a screw 418c, a screw 418d, a screw 418e, and a screw 418f functioning as a fixing portion around the optical axis 70 from the outside. During screw fastening (during fixing by screws), as described above, the barrel unit 404 is inside the base 601. A hole (hole portion) 611 that allows direct access to a holding structure of the barrel unit 404 in this state is provided. That is, the hole 611 is formed to pass through a movable range of the barrel unit 404. While details will be described below, the barrel base 403 is held from the hole 611, so that it is possible to assemble the main guide bar 602 and the ball bearings in a state of being distant from each other. Here, if the screws are fastened in a state in which the ball bearings are in contact with the main guide bar 602, a dent may occur in the guide bar. For this reason, a configuration to incorporate the main guide bar 602 and the ball bearings distant from each other as in the present embodiment is made, so that it is possible to reduce a possibility that a dent occurs.

In the present embodiment, a structure in which the ball bearings are biased to the main guide bar 602 and the fourth group unit 400 is guided is made. In such a structure, if a dent occurs in a region where the main guide bar 602 is in contact with the ball bearing, the fourth group unit 400 vibrates when passing through the dent during driving and a driving characteristic of the VCM may be deteriorated. That is, the ball bearings are incorporated distant from the main guide bar 602, so that it is possible to prevent deterioration of the driving characteristic of the VCM.

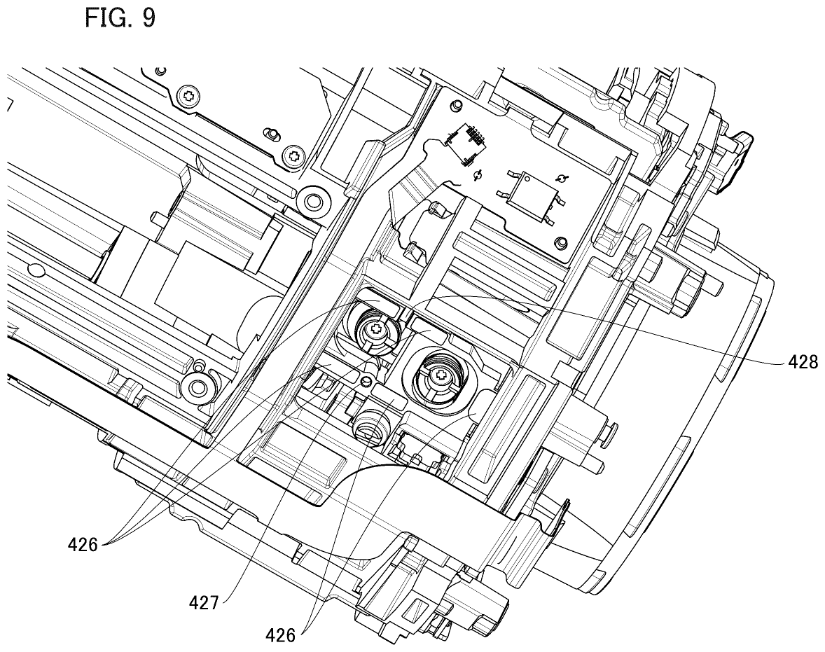

FIG. 9 is an external view illustrating a receiving surface of the barrel unit 404 during assembling of the guide unit base 407. FIG. 9 is an external view as viewed from an opposite side to the guide unit base 407. In this case, the fourth group unit 400 is at a certain position in a range in which the fourth group unit 400 can be driven in a unit state. Furthermore, in this case, the barrel base 403 has holding surfaces 426 substantially perpendicular to a screw fastening direction, a positioning hole 427, a rotation regulating groove 428 accessible via the hole 611 at this position. Each of such portions also functions as a holding structure that can hold the barrel.

In this case, the hole 611 has a size enough to access at least some of the holding surfaces 426, the positioning hole 427, and the rotation regulating groove 428 in a certain phase in which the barrel base 403 can be driven. The holding surfaces 426 are surfaces each having a tangent on a side facing the fixing portion (screw 418a) across the optical axis 70 as viewed from the direction along the optical axis 70. The holding surfaces 426 are provided substantially directly below the six screws (fixing portion) represented by the screw 418a. Then, a jig for receiving is put from the hole 611 during fixing by screws, the holding surfaces 426 can be supported by the jig. Simultaneously, it is possible to suppress the rotation of the barrel unit 404 using the same jig by inserting two pins provided in the jig into the positioning hole 427 and the rotation regulating groove 428. That is, it is possible to suppress rotation during screw fastening. For this reason, it is possible to prevent the barrel unit 404 and the guide unit base 407 positioned in the barrel unit 404 from rotating with a force in a rotation direction of screw fastening and from bringing the ball bearings and the main guide bar 602 into contact with each other.

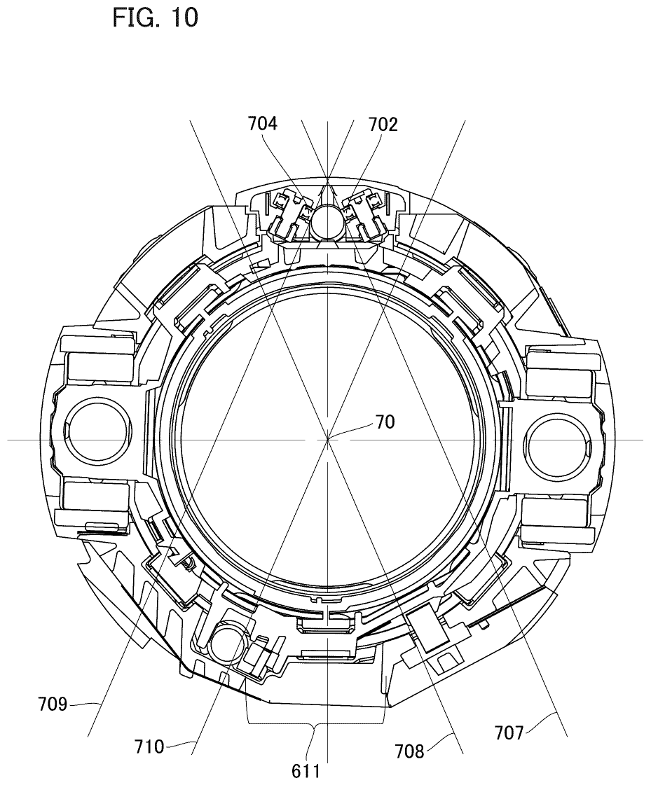

FIG. 10 is a cross-sectional view illustrating a position of the hole 611. The hole 611 is provided in a region opposite to the guide unit base 407 in a surface perpendicular to the optical axis 70 across the optical axis 70.

A line that is parallel to a tangent 707 at the first contact 702, which is a contact between the main guide bar 602 and the ball bearing, and passes through the optical axis 70 is referred to as a line 708. The ball bearing 408a and the main guide bar 602 can be made distant from each other by applying a force to the barrel unit 404 and the guide unit base 407 in a direction perpendicular to the line 708 toward the ball bearing 408a. That is, when a circle is drawn with the optical axis 70 as a center, it is possible to separate the ball bearing 408a and the main guide bar 602 by dividing the circle by the line 708 and receiving the barrel unit 404 by a tangent on an arc of a region where there is no ball bearing 408a.

When a line that is parallel to a tangent 709 at the second contact 704 and passes through the optical axis 70 is referred to as a line 710, the ball bearing 408b and the main guide bar 602 can be incorporated distant from each other using a similar way of receiving. That is, when a circle is drawn with the optical axis 70 as a center, the ball bearings can be incorporated distant manner by providing a receiving surface in a region facing the main guide bar 602 across the optical axis 70 in a region divided by the line 708 and the line 710. In this way, the hole 611 is provided in a region divided by the lines that are parallel to the tangent (line 708) at the first contact 702 and the tangent (line 710) at the second contact 704 and pass through the optical axis, in the surface perpendicular to the optical axis 70.

Next, a relationship between the barrel unit 404 and the base 601 when the holding surfaces 426 are received will be described with reference to FIG. 5. The barrel base 403 has a clearance 711 (first clearance) in a radial direction (a direction perpendicular to the optical axis), that is, in a direction connecting the optical axis 70 and the center of the main guide bar 602 in the state of the lens barrel 10. In this case, the clearance 711 is formed between a protruding portion 429 provided in the barrel base 403 and a protruding portion 430 distant from the protruding portion 429 in the optical axis 70 direction and the main guide bar 602. That is, the barrel base 403 has the protruding portion 429 and the protruding portion 430 as two protruding portions formed distant from each other in the optical axis 70 direction between the barrel base 403 and the main guide bar 602. The barrel base 403 has a clearance 712 (second clearance) between the base 601 and the barrel unit 404 in a radial direction or a direction connecting the optical axis 70 and the center of the main guide bar 602.

In this case, the clearance 711 is a clearance smaller than the clearance 712. That is, when the holding surfaces 426 are held by the jig, the base 601 falls in a direction toward the jig. Thus, the main guide bar 602, and the protruding portion 429 and the protruding portion 430 are brought into contact with each other and held. The protruding portion 429 and the protruding portion 430 also function as a part of a holding structure in the lens barrel 10. In this case, since the protruding portion 429 and the protruding portion 430 are not in contact in the state of the lens barrel 10, even if a dent or the like occurs due to the contact of the protruding portions, there is no influence on the driving characteristic of the VCM. Furthermore, since the main guide bar 602 and the barrel unit 404 are in direct contact with each other, even if the barrel base 403 is deformed by a force of screw fastening, the main guide bar 602 interlocks with the deformation of the barrel base 403. With this, since the position of the main guide bar 602 is changed, it is possible to suppress the contact of the ball bearings and the main guide bar 602.

The lens barrel 10 having the configuration described above is provided, so that it is possible to provide an image capturing apparatus including a lens barrel having a compact size and good optical performance.

While the preferred embodiment of the present invention has been described above, the present invention is not limited to the embodiment, and various modifications and changes can be made without departing from the spirit and scope of the present invention. For example, the VCM may be configured with configurations other than the configuration described above, that is, other actuators. Furthermore, in the present embodiment, while an example where the four ball bearings are provided has been described, a configuration may be made in which two guide units each having two ball bearings of which contacts do not match in the optical axis 70 direction are provided. Alternatively, a configuration may be made in which three ball bearings are at positions separated in the optical axis 70 direction, two contacts substantially match (have the same phase) as viewed from the optical axis 70 direction, and one point may be different.

In the present embodiment, while an example where the two ball bearings substantially match in the optical axis 70 direction has been described, ball bearings may not match in the optical axis 70 direction. Similarly, a configuration may be made in which front and rear ball bearings in the optical axis OA direction do not overlap in the optical axis 70 direction.

While an example where the hole and the groove serving as a holding portion for suppressing rotation during screw fastening in the present embodiment has been described as an example, a rotation suppressing portion such as a groove and a groove or a protruding shape and a protruding shape may be configured.

In the present embodiment, an example where the hole and the holding structure are provided on a side facing the guide bar across the optical axis 70 has been described. However, the present invention is not limited thereto, two holes may be provided across a line connecting the guide bar and the optical axis 70, and holding structures may be provided on both sides to hold a barrel unit.

The embodiments described above are merely representative examples, and various modifications and changes may be made to the embodiments when the present invention is implemented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-155653, Sep. 21, 2023, which is hereby incorporated by reference wherein in its entirety.

What is claimed is:

1. A lens barrel comprising:
a lens;
a barrel that holds the lens and is movable in a direction along an optical axis, a base member that has a cylindrical shape and is positioned on an outer periphery of the barrel;
a guide bar of which at least one end is fixed to the base member; and
a guide unit having a biasing member fixed to the barrel by a fixing portion and configured to bias a first rotating element and a second rotating element to the guide bar,
wherein, on a plane perpendicular to the optical axis, distances between a first contact that is a point where the guide bar and the first rotating element are in contact with each other, a second contact that is a point where the guide bar and the second rotating element are in contact with each other, and the biasing member and an optical axis center are longer than a distance between a center of the guide bar and the optical axis center,
the guide unit overlaps the base member as viewed along the optical axis, and
the biasing member is disposed between the first contact and the second contact as viewed along the optical axis.

2. The lens barrel according to claim 1, further comprising:
a hole portion that passes through a movable range of the barrel in a state in which the barrel, the base member, the guide bar, and the guide unit are fixed; and
a holding structure configured to hold the barrel via the hole portion.

3. The lens barrel according to claim 1,
wherein a first clearance that is a clearance between the barrel and the guide bar in a direction perpendicular to the optical axis is smaller than a second clearance that is a clearance between the base member and the barrel in the direction perpendicular to the optical axis.

4. The lens barrel according to claim 1,
wherein the guide unit has a position detection unit that detects a position of the lens.

5. The lens barrel according to claim 1,
wherein a third clearance that is a clearance between the barrel and the base member or a first fixing member fixed to the base member in an optical axis direction is smaller than a fourth clearance that is a clearance between the barrel and the base member in the optical axis direction.

6. The lens barrel according to claim 1,
wherein a fifth clearance that is a clearance between the barrel and the base member or a second fixing member fixed to the base member in an optical axis direction is smaller than a sixth clearance that is a clearance between the guide unit and the base member in the optical axis direction.

7. The lens barrel according to claim 1,
wherein the guide unit has the first rotating element, a guide base to which the second rotating element is fixed, and a reinforcing member having a rigidity different from that of the guide base, and
the reinforcing member is fixed across the fixing portion, the first contact, and the second contact as viewed from a direction perpendicular to the optical axis.

8. The lens barrel according to claim 1,
wherein the guide unit has a third rotating element that overlaps the first rotating element as viewed from an optical axis direction and is disposed distant from the first rotating member in the optical axis direction, and
the biasing member is provided between the first contact and a third contact that is a point where the third rotating element is in contact with the guide bar in the optical axis direction.

9. The lens barrel according to claim 2,
wherein the hole portion is provided in a region divided by lines that are parallel with tangents at the first contact and the second contact and pass through the optical axis, in a surface perpendicular to the optical axis.

10. The lens barrel according to claim 2,
wherein the holding structure is configured with at least one of a groove, a hole, and a protruding portion provided in the barrel.

11. The lens barrel according to claim 2,
wherein the holding structure is configured with a surface having a tangent provided on a side facing the fixing portion across the optical axis as viewed from an optical axis direction.

12. The lens barrel according to claim 4,
wherein the position detection unit is a scale for position detection provided in the guide unit and a light emitting sensor provided on an outer periphery of the base member.

13. The lens barrel according to claim 4,
wherein the position detection unit is disposed at a position overlapping at least the first rotating element as viewed from an optical axis direction.

14. The lens barrel according to claim 1,
wherein the biasing member is configured with a magnet that is attracted to the guide bar made of a soft magnetic material.

15. The lens barrel according to claim 7,
wherein the reinforcing member is a yoke attracted to a magnet.

16. The lens barrel according to claim 7,
wherein the reinforcing member is disposed at a position overlapping the first rotating element or the second rotating element as viewed from an optical axis direction.

17. The lens barrel according to claim 1,
wherein the barrel has two protruding portions formed distant from each other in an optical axis direction between the barrel and the guide bar.

18. The lens barrel according to claim 1, further comprising:
a holding member that holds the other end of the guide bar.

19. An interchangeable lens comprising:
a mount portion that is mounted on an image capturing apparatus; and
the lens barrel according to claim 1.

20. An image capturing apparatus comprising:
an image capturing element; and
the lens barrel according to claim 1.
